(19) United States
(12) Patent Application Publication
(10) Pub. No.: US 2009/0295106 A1
(43) Pub. Date: Dec. 3, 2009

(54) Machine for the transportation of physically challenged persons

(76) Inventor: Mark Alfred Kallhoff, Canby, MN (US)

Correspondence Address: Mark Kallhoff, 206 Lyon Ave N, Canby, MN, 56220, US

(21) Appl. No.: 12/156,332

(22) Filed: May 30, 2008

(51) Int. Cl. B62M 1/14

(52) U.S. Cl. 280/29

(57) ABSTRACT

A machine for the transportation of physically challenged persons with a open frame design to allow persons with lower physical disabilities the to transfer from wheel chair and rotate into position without encumbrances, provision for foldable wheel chair directly behind driver for complete operation in an independent environment, provision for fueling with out dismounting from machine and or assistance from a full service facility, and rotating seat with secure position locking mechanism to assist driver in mounting/demounting/fueling/placement of chair and general machine maintenance.

### CROSS REFERENCE TO RELATED APPLICATIONS

This application is based on provisional application Ser. No. 60/891,896, filed on Feb. 27, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of transportation and more specifically to a machine for the transportation of physically challenged persons.

Persons with lower body physical disabilities and stabilization issues, desiring to ride a motorcycle have had to endure adaptations from two wheel motorcycles. Not being able to swing there leg over the traditional seat to mount a motorcycle, the design had to employ an open front end section that provides a space for the driver to swing their legs into the forward position. Necessitating the need for a seat that rotates and locks along with for and aft adjustability. For those drivers with lower paralysis. The entire machine had to be hand operated and controlled. A provision for a foldable wheel chair directly behind the driver. Enables the driver to transfer, placement of wheel chair and operate completely in an independent environment. Unlike other attempts to adapt two wheel motorcycles with side cars, this design enables the driver to position oneself up and close to the handle bars to facilitate ease of operation and the perspective of riding a conventional motorcycle. The transverse rear located engine enables the design to allow the open front frame section.

Motorcycle trike drivers with lower body disabilities, have had to be located via a side car platform or rear chariot style machine due to there inability to swing a leg over a upper fork neck support or backbone of the typical motorcycle. Most trikes manufactured today are adaptations to manufactured motorcycles. Other designs still utilize the backbone for upper fork neck support. Once again prohibiting the challenged driver from mounting and demounting from the trike.

Locating the drive of a trike in a side car or chariot arrangement, necessitates the need for a steering apparatus that is long and cumbersome. Coordinated control issues arise from the steering apparatus that do not provide a one to one steering aspect ratio or locating the drive of the trike in an offset location. The technology of this design allows the driver to locate oneself in close proximity of the steering/handlebars. Providing coordinated steering and control

### BRIEF SUMMARY OF THE INVENTION

The primary object of the invention is to provide a motorcycle type machine for physically challenged drivers.

Another object of the invention is to provide a articulating/rotating seat for ease of wheel chair transfer to and from machine.

Another object of the invention is to provide a seat that provides upper body support for drivers with paralysis or lack of upper body stability.

A further object of the invention is to provide a machine that is operated by hand control only.

Yet another object of the invention is to provide a handle bar design that supports ease of articulation for the challenged driver.

Still yet another object of the invention is to provide a transverse engine placement to compliment driver access and derivability.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for the transportation of physically challenged persons comprising: a open frame design to allow persons with lower physical disabilities the means to transfer from wheel chair and rotate into position without encumbrances, provision for foldable wheel chair directly behind driver for complete operation in an independent environment, provision for fueling with out dismounting from machine and or assistance from a full service facility, and rotating seat with secure position locking mechanism to assist driver in mounting/demounting/fueling/placement of chair and general machine maintenance.

In accordance with a preferred embodiment of the invention, there is disclosed a process for the transportation of physically challenged persons comprising the steps of: an open frame design to allow persons with lower physical disabilities the means to transfer from wheel chair and rotate into position without encumbrances, provision for foldable wheel chair directly behind driver for complete operation in an independent environment, provision for fueling with out dismounting from machine and or assistance from a full service facility, and rotating seat with secure position locking mechanism to assist driver in mounting/demounting/fueling/placement of chair and general machine maintenance.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Drawing is a perspective view of the invention.

FIG. 1-7 is a perspective view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

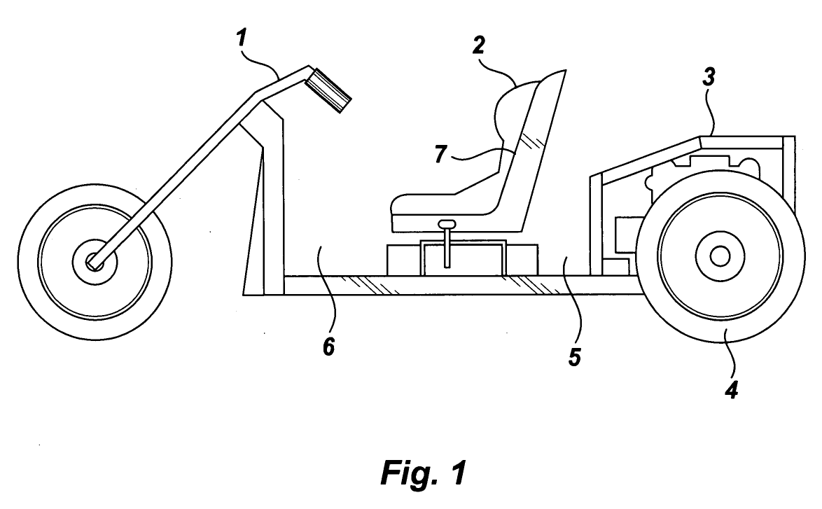

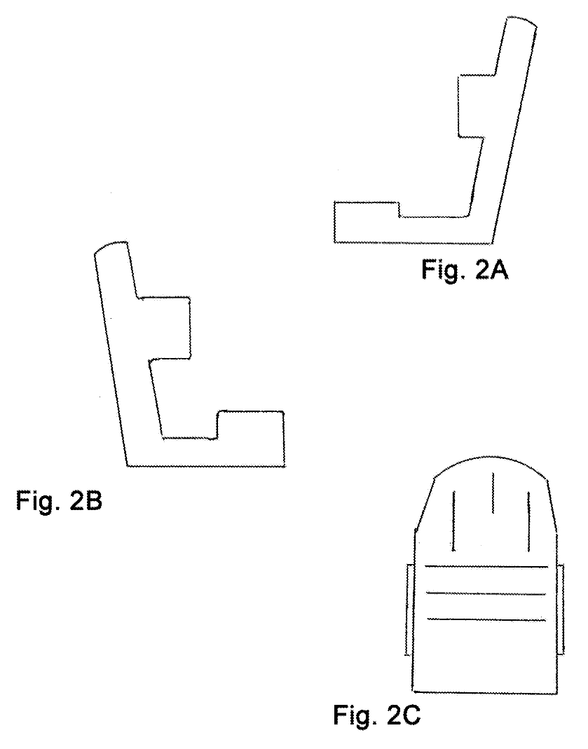

In accordance with the present invention, FIGS. 1-7 outline the overall embodiment and construction of the machine highlights. The specific structure and assemblage of the machine invention allows the physically challenged drive the opportunity to transfer onto the machine and into the specifically designed seat, rotate and position lock the seat, fold and place foldable wheel chair directly behind and into provision for storage of said wheel chair. Rotate and lock seat to forward position, adjust seat for or aft with relation to handlebars for greatest comfort and coordination control. All accomplished in accordance with the open frame specific structure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for the transportation of physically challenged persons comprising:
a open frame design to allow persons with lower physical disabilities the means to transfer from wheel chair and rotate into position without encumbrances;
provision for foldable wheel chair directly behind driver for complete operation in an independent environment;
provision for fueling with out dismounting from machine without assistance from a full service facility; and
rotating seat with secure position locking mechanism to assist driver in mounting/demounting/fueling/placement of chair and general machine maintenance.

2. A process for the transportation of physically challenged persons comprising the steps of:
a open frame design to allow persons with lower physical disabilities the means to transfer from wheel chair and rotate into position without encumbrances;
provision for foldable wheel chair directly behind driver for complete operation in an independent environment;
provision for fueling with out dismounting from machine without assistance from a full service facility; and
rotating seat with secure position locking mechanism to assist driver in mounting/demounting/fueling/placement of chair and general machine maintenance.
